(19) United States
(12) Patent Application Publication
(10) Pub. No.: US 2007/0295045 A1
(43) Pub. Date: Dec. 27, 2007

(54) Flat key

(75) Inventor: Harald Neumayer, Vienna (AT)

Correspondence Address: K.F. ROSS P.C., 5683 RIVERDALE AVENUE, SUITE 203 BOX 900, BRONX, NY, 10471-0900, US

(73) Assignee: EVVA-Werk Spezialerzeugung von Zylinder- und Sicherheitsschlossern Gesellschaft m.b.H & Co. KG

(21) Appl. No.: 11/809,189

(22) Filed: May 31, 2007

(30) Foreign Application Priority Data
Jun. 1, 2006 (AT) A951/2006

(51) Int. Cl. E05B 19/06

(52) U.S. Cl. 70/409

(57) ABSTRACT

A deep longitudinally extending groove cut into a face of a key blade is either of isosceles-triangle or right-triangular cross section. In addition the face has a shallow longitudinally extending groove parallel to and offset from the deep groove and having a pair of generally planar narrow side flanks extending from the one side face to a common shallow apex line to give the shallow groove a triangular section. One of the narrow side flanks has a transverse width equal to generally half the transverse width of one wide side flank of the deep groove, and the other of the narrow side flanks has a transverse width substantially smaller than the transverse width of the one wide side flank of the deep groove.

### FIELD OF THE INVENTION

The present invention relates to a flat key.

### BACKGROUND OF THE INVENTION

A standard key as described in U.S. Pat. Nos. 4,168,617, 4,368,629, and 4,612,787 has a flat key body having a longitudinally extending blade having a front edge formed with transversely directed bitting, an opposite longitudinally extending back edge, and a pair of oppositely directed side faces. One, and normally both, of these side faces is formed with a deep longitudinally extending groove having one generally planar wide side flank of a wide predetermined transverse width, extending at an acute angle to the one side face, and terminating inside the key blade at a longitudinally extending deep apex line and another generally planar wide side flank extending between the apex line and the one side face. This other wide side flank extends either at generally the same acute angle as the one wide side flank so as to give the deep groove an isosceles section or at a generally right angle to the side face to give the deep groove a right-triangular section.

With this system there are therefore three different deep grooves that can be formed on each key face. The respective cylinders are of course formed internally with complementary longitudinally extending ridges. By varying the mix of shapes it is possible to produce a wide variation in keys that cannot even be inserted into the wrong cylinders. This greatly increases security, since on top of the different wards or grooves, the keys are differently bitted.

A problem with this system is that, with time keys are lost and replaced. In addition in a multiple dwelling equipped with such keys soon a large number of keys are in the hands of nonresidents. If it is desired to tighten security, the only solution is to provide everyone with new keys and replace at least the cylinders of all the locks.

In the present invention there is the added issue that, of the known locks and keys under the “GPI” brand, millions of locks and keys have been installed or sold. Thus it would be desirable to adapt existing lock systems in such a manner that the new profile elements are compatible with existing elements.

### OBJECTS OF THE INVENTION

It is therefore an object of the present invention to provide an improved flat key.

Another object is the provision of such an improved flat key that overcomes the above-given disadvantages, in particular that allows a lock system having a number of different locks to be upgraded incrementally, that is by issuing new keys and only replacing the critical cylinders, but in such a manner that the new keys can operate both the new cylinders and the old cylinders, but the old keys cannot operate the new cylinders.

### SUMMARY OF THE INVENTION

A key has according to the invention a flat key body having a longitudinally extending blade having a front edge formed with transversely directed bitting, an opposite longitudinally extending back edge, and a pair of oppositely directed side faces at least one of which is formed with a deep longitudinally extending groove having one generally planar wide side flank of a wide predetermined transverse width, extending at an acute angle to the one-side face, and terminating inside the key blade at a longitudinally extending deep apex line and another generally planar wide side flank extending between the apex line and the one side face. This other wide side face extends either at generally the same acute angle as the one wide side flank so as to give the deep groove an isosceles section or at a generally right angle to the one side face to give the deep groove a right-triangular section. According to the invention a shallow longitudinally extending groove parallel to and offset from the deep groove has a pair of generally planar narrow side flanks extending from the one side face to a common shallow apex line to give the shallow groove a triangular section. One of the narrow side flanks has a transverse width equal to generally half the transverse width of the one wide side flank of the deep groove, and the other of the narrow side flanks has a transverse width substantially smaller than the transverse width of the one wide side flank.

With this system, therefore, it is possible to upgrade a typical office-building or multiple-dwelling lock system having a large number of substantially identical locks all openable with the same key, for instance some to critical exterior doors and other to less critical internal rooms. This is done by issuing all the users new keys, something that can be done at an affordable costs. The new keys have, in the place of one or more of the deep grooves of the keys they replace, one or more of the new shallow grooves. These new keys will be able to operate all of the old locks, since the

### BRIEF DESCRIPTION OF THE DRAWING

The above and other objects, features, and advantages will become more readily apparent from the following description, reference being made to the accompanying drawing in which:

FIG. 1 is a side view of a flat key according to the invention;

FIG. 2 shows the principle for the shape of the groove profile in cross-section;

FIGS. 3a through 3f show different variations for the inventive profile grooves;

FIG. 4 is a section through a key with all of the variation possibilities for the longitudinal grooves;

FIGS. 5 and 6 are examples of key profiles, FIG. 5 also showing the shape of the key way; and

FIG. 7 shows another example for the groove scheme in accordance with FIG. 2.

### SPECIFIC DESCRIPTION

As seen in FIG. 1 a key has longitudinal grooves 2 and 3 on one or both faces 1. The key front edge 4 is provided in a known manner with bitting notches 5 that actuate pin tumblers of an unillustrated lock. The key rear edge 6 and the key grip 7 are also shown.

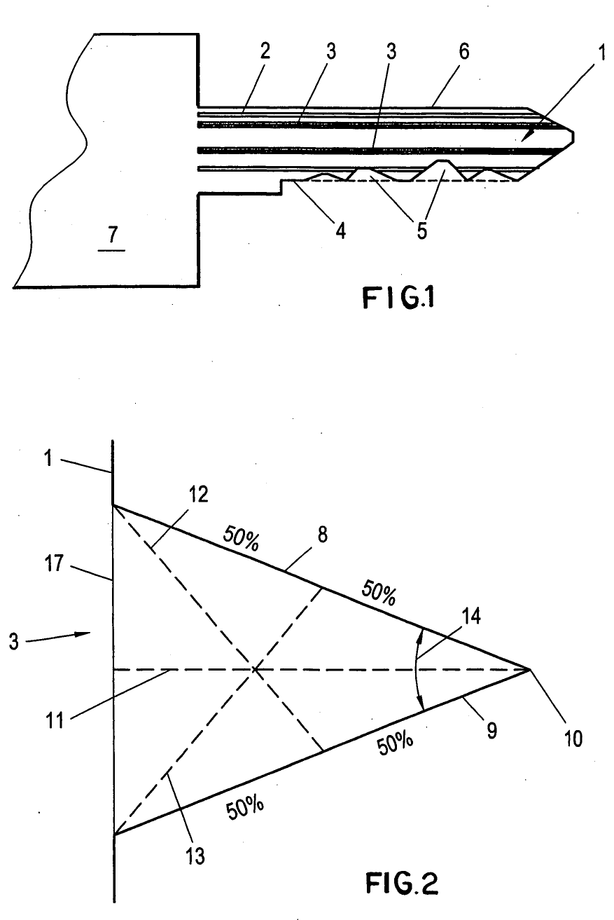

Each of the longitudinal grooves 3 is made in accordance with the scheme illustrated in FIG. 2. The basic triangle is drawn with the solid line formed by the two basic flanks 8, 9 and the line 17 corresponding to the lateral surface of the key blank. These basic flanks intersect at the line of intersection 10. In the key, the line of intersection 10 extends across the entire shaft length of the key parallel to the key side surface 1. As known from the above-cited patents, the basic triangle can be split along the apex line 11 so that three variations—one isosceles, two right triangle—are available.

In accordance with the present invention, another two groove flanks 12 and 13 can be used that bisect the flanks 8 and 9 so that only 50% of the flank length of the groove actually remains on the key, as is drawn in in FIG. 2 in dashed lines.

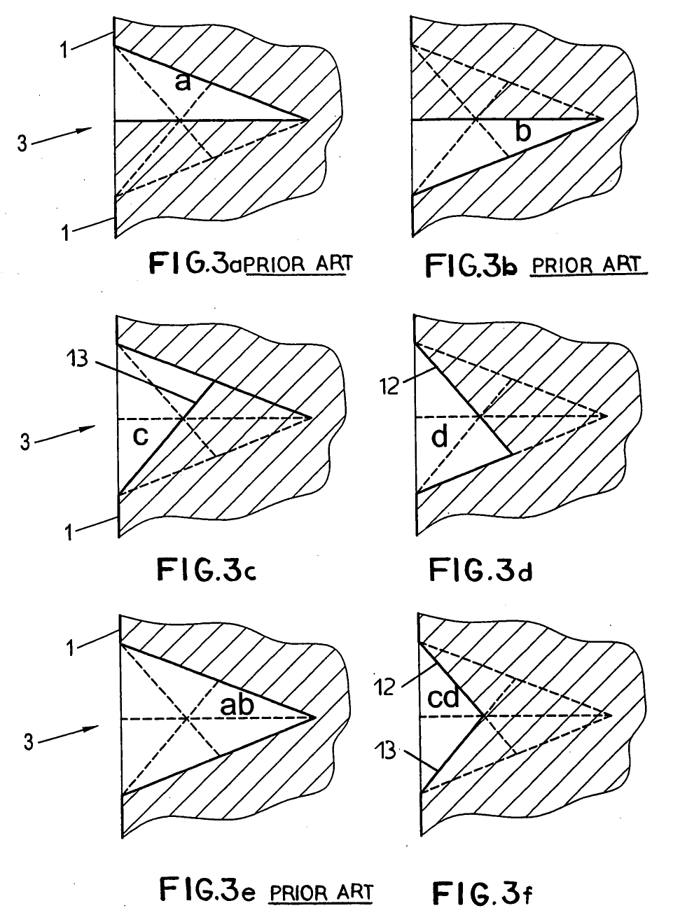

The groove scheme in accordance with FIG. 2 shows all possible variations in a single basic groove, both those of the prior art and those according to the instant invention. These variations are shown in FIGS. 3a-3f. The variation ab corresponds to the basic prior-art triangle. Thus starting from a single basic triangle, six profile variations can be formed, which significantly increases the number of variations. Despite the high number of these variation possibilities, the cross-sectional surfaces of the individual variation elements are large enough to provide the required locking certainty. The longitudinal grooves that are shown open to the left in FIGS. 3a-3f can likewise be arranged open to the right on the other side face of the key.

As an example, FIG. 4 shows the section through a complete key, whereby three variation grooves 3 are shown on the left-hand side and two variation grooves 3 in on the right-hand side. Due to space considerations, the longitudinal profile groove 2 running along the back key edge 6 is not varied in the manner described but rather is preferably always of with the same depth.

As can be seen, the longitudinal profile grooves corresponding to prior-art FIGS. 3a, 3b, and 3e extend beyond a longitudinal midplane 20 of the key so that an overlapping profile can extend all the way through. The profile is termed overlapping when the longitudinal profile grooves reach or extend beyond the longitudinal midplane at least three locations. In the design in accordance with FIG. 4, the apices 10 are beyond the longitudinal midplane 2 from the open mouth of the respective groove 3, specifically in the planes 19 that run parallel to the longitudinal midplane 20.

In a preferred manner, the apex angle 14 of each basic triangle is always the same and the flank lengths and their median lines are each measured from the key side surfaces. The latter is true even when in accordance with FIG. 4 a tapered profile is provided. In this case, an outer face 15 of the key runs at a small acute angle to the longitudinal midplane 20 over at least a portion of the key height, here the toward the bitted front edge 4. This tapered design of the key cross-section ensures that the associated locking channel of the cylinder lock can be made narrower at the key bitting 5 in order to prevent improper locking. Moreover, the tapered design makes it more difficult to duplicate the key.

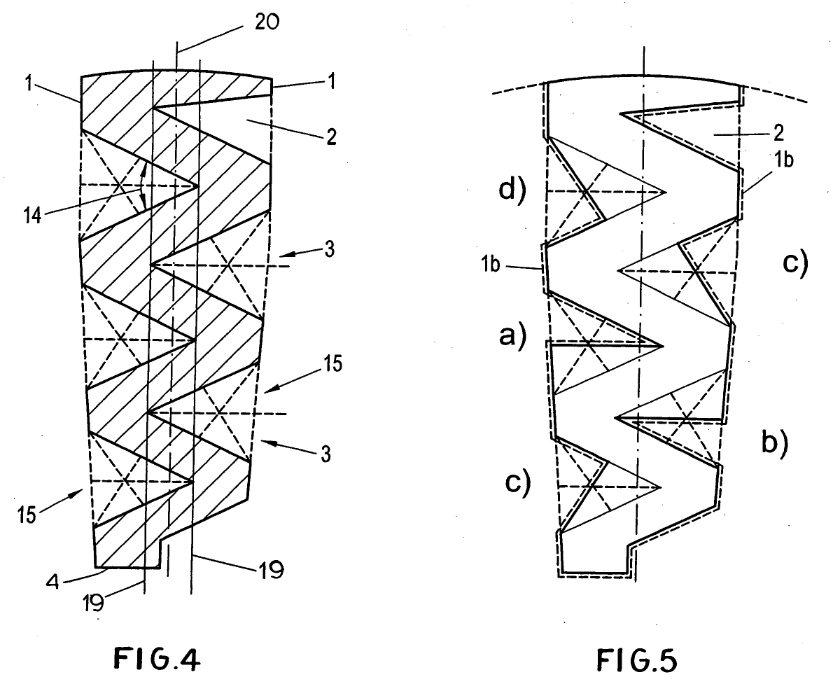

FIG. 5 shows an example for the variations d, a, and c on the left-hand face of the key and c, b on the right-hand face of the key. The corresponding profile of the key way 1b is drawn in with a broken line. FIG. 6 shows variations b, d, and a on the left and cd and a on the right.

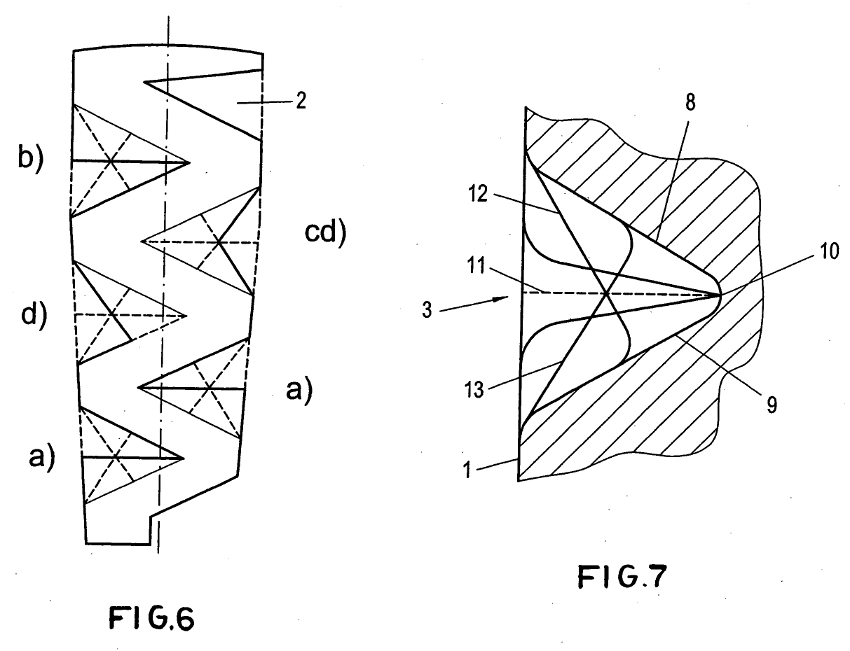

FIG. 7 shows a design of the groove scheme analogous to that in FIG. 2 that is preferred in practice. This shape takes into account the clearances between metal surfaces sliding on one another that are necessary when producing longitudinal grooves and in use.

It is obvious that the profiles in the associated key way of the lock must be made analogous to the key profile. In the simplest case, a longitudinal profile groove in the key is of complementary shape to a longitudinal profile rib in the key way. In any case, the entire profile of the key way must always be large enough for the cross-sectional profile of the key to fit into it.

The present profiling system can also be used to remedy the disadvantage of earlier systems. Since with time keys are lost, security is no longer assured. Now new keys can be provided that possess one of the shallow grooves c or d or cd in addition to the existing grooves a or b. Lock cylinders with security relevance, e.g. on the exterior doors of a building, will then be exchanged for new lock cylinders that have at a certain preselected positions only one of the ribs that correspond to the shallow grooves c or d or cd in the key. Thus it is possible for the new keys to lock all cylinders, specifically the old and the new lock cylinders, where the security relevance is not so high. After the cylinders with security relevance have been exchanged, these new lock cylinders can only be locked by the new keys. Thus the technical locking value of a lock system is restored with a lower degree of complexity than if a total exchange of all lock cylinders and keys were necessary.

Moreover, with the inventive profiling system it is possible to expand group key systems. Existing group key systems have a fixed structure that cannot be expanded without problems. With the ribs analogous to the shallow grooves c and d or cd, now additional group keys can be formed. Thus it is assured that new keys with the shallow grooves c, d, or cd do not lock in existing cylinders that have one of the ribs in accordance with the longitudinal grooves a or b.

Moreover, it is possible to expand main key systems with no problem. Additional individual keys can be formed in the main key system using the shallow grooves c and d or cd. Thus main key systems can easily be expanded without affecting the existing structure of the system.

I claim:

1. A key comprising:
a flat key body having a longitudinally extending blade having a front edge formed with transversely directed bitting, an opposite longitudinally extending back edge, and a pair of oppositely directed side faces at least one of which is formed with
a deep longitudinally extending groove having one generally planar wide side flank of a wide predetermined transverse width, extending at an acute angle to the one side face, and terminating inside the key blade at a longitudinally extending deep apex line and another generally planar wide side flank extending between the apex line and the one side face either at generally the same acute angle as the one wide side flank so as to give the deep groove an isosceles section or at a generally right angle to the one side face to give the deep groove a right-triangular section; and
a shallow longitudinally extending groove parallel to and offset from the deep groove and having a pair of generally planar narrow side flanks extending from the one side face to a common shallow apex line to give the shallow groove a triangular section, one of the narrow side flanks having a transverse width equal to generally half the transverse width of the one wide side flank of the deep groove.

2. The key defined in claim 1 wherein the key blade is had a midplane extending substantially parallel to the side faces, the midplane lying between the apex line of the deep groove and the one side face.

3. The key defined in claim 2 wherein each side face is formed with at least one of the deep grooves.

4. The key defined in claim 1 wherein all of the apex lines are parallel but offset from each other.

5. The key defined in claim 1 wherein each side face is formed with a plurality of the deep grooves and all the apex lines of the deep grooves of each face lie in a common respective plane.

6. The key defined in claim 5 wherein one of the side faces is formed with three of the deep grooves and the other of the eside faces is formed with two of the deep grooves and the deep grooves of the one side alternate with the edeep grooves of the other side.

7. In combination with the key defined in claim 1, a cylinder having a keyway with ribs complementary to the deep and shallow grooves.
